(19) United States
(12) Patent Application Publication
(10) Pub. No.: US 2003/0230892 A1
(43) Pub. Date: Dec. 18, 2003

(54) Method of charitable fund raising utilizing pseudo securities

(76) Inventor: Robert J. Bednar JR., Naples, FL (US)

Correspondence Address: Robert S. Lipton, Esquire, LIPTON, WEINBERGER & HUSICK, 201 North Jackson Street, P.O. Box 934, Media, PA, 19063-0934, US

(21) Appl. No.: 10/427,722

(22) Filed: Apr. 30, 2003

Related U.S. Application Data
(63) Continuation of application No. 09/671,232, filed on Sep. 28, 2000, now abandoned.

(51) Int. Cl. B42D 15/00; B42D 15/10

(52) U.S. Cl. 283/72; 283/117

(57) ABSTRACT

The invention is a method of charitable fund raising incorporating “pseudo securities” emulating actual financial securities, such as currency, stocks, bonds and the like, but depicting the image of a celebrity on the face of the pseudo security. The pseudo security is used by charities as a collectible fund-raising premium to donors.

### CROSS-REFERENCE TO RELATED APPLICATIONS

This application claims the benefit of U.S. patent application Ser. No. 09/671,232 filed Sep. 28, 2000 entitled METHOD OF CHARITABLE FUND RAISING UTILIZING PSEUDO SECURITIES.

### BACKGROUND OF THE INVENTION

1. Field of the Invention

The invention comprises a method of charitable fund raising utilizing collectible pseudo financial securities bearing the likeness of celebrities and utilized by a charity or by the supplier of the pseudo security as a premium to assist in raising money for the charity.

2. Description of the Related Art

Most modern human endeavor requires money. Charities are uniquely dependent upon the financial beneficence of others to accomplish charitable goals. As a result, charities are required to engage in intensive and ever-changing fund raising activities. Various methods exist for raising money by or for charities, which may be divided into two general categories. The first category is the outright plea for funds from a charitable donor. For a charitable fund-raising campaign based on an outright plea to be successful, the charity first must identify those persons who share the goals of the charity. The charity then must couch a plea in terms that the donor finds attractive, all for the purpose of convincing the donor to part with his or her hard-earned cash. A classic example of the outright plea for funds is the telethon. The outright plea for funds suffers the disadvantage that only a limited number of persons are willing to part with money for the intellectual satisfaction of knowing that good works will be done by the charity.

The second category of charitable fund-raising is the use of the premium to entice donors to the charity. A “premium” is some good or service offered by the charity that the donor finds attractive. Familiar examples are the bake sale and the marketing of cookies by the Girl Scouts of America™. The premium offers the giver a tangible self-justification for making a donation, when the intellectual satisfaction of good works is not sufficient to loosen money from wallet. The use of a premium can substantially increase donor participation in a charitable fund-raising campaign.

For successful fund raising, the cost of the premium must be low in comparison to the donation received. The present invention provides a premium of very low cost, and may physically comprise ink on paper. A potential donor may nonetheless find the premium of the present invention very desirable because the premium comprises a “collectible.” A great many people enjoy collecting products, particularly when the products are produced as a limited edition or in a series. If a series of products captures the imagination of collectors, the perceived value of the product is very high and collectors are willing to pay a great deal of money for products in the series irrespective of the intrinsic value of the product. A familiar example is the Beanie Babies™ series of stuffed toys.

The premium of the present invention comprises a low cost “pseudo security.” For the purposes of this application, “pseudo security” means a document resembling an actual financial security, but bearing the likeness of any of a number of celebrities and having no or very small value as a financial security. For the purposes of this application, the term “financial security” means a stock, bond, check, negotiable instrument, item of currency, or other written document representing financial value. The collectible nature of the pseudo securities of the present invention stems from the depiction of celebrities and from the scarcity and difficulty of duplication of the pseudo securities. For the purposes of this application, the term “celebrity” means a person, place or thing that may be of interest to a potential donor.

The value of the pseudo security as a fund-raising tool also stems from the desire of the donor to acquire a single pseudo security or to collect an entire series of said pseudo securities. For pseudo securities issued in a series, the charity is required to convince the donor to donate funds only once. The donor, who is now a collector, subsequently is motivated to donate for the purpose of collecting the entire series of pseudo securities. The pseudo security has inherent value which is the basis for the donor making the contribution to the applicable charity; it is not intended to be exchanged for services or for a product or for anything else of value.

In the present invention, the supplier of the pseudo security makes a profit producing and supplying the pseudo security to the charity. The charity makes a profit on a donation and provides the pseudo security to the donor. The donor enjoys collecting the various versions of the pseudo security depicting the favorite celebrities of the donor and gains satisfaction from supporting the good works of the charity.

The actual marketing of the pseudo security to donors can be performed by either the charity, by the supplier of the pseudo securities, or by a third party.

### SUMMARY OF THE INVENTION

The present invention is a method of charitable fund raising comprising producing a pseudo security, as defined above, and selling the pseudo security to a charity. The charity then provides the pseudo security to donors as a fund-raising premium in exchange for a donation. In an alternative embodiment, the supplier of the pseudo security markets the pseudo security as a premium for donations in the name of the charity, accepts donations on behalf of the charity, delivers the pseudo security to the donor, retains a portion of the donation and forwards the balance of the donation to the charity.

The pseudo security bears the image of any of a number of celebrities, making the pseudo security desirable to collectors. The pseudo security is valuable as a collectible because the pseudo security is printed using techniques and design elements of actual securities, making the pseudo security difficult to duplicate and assuring the authenticity of each of the pseudo securities. The value of the pseudo security may be further enhanced by restricting the supply of each pseudo security through use of a limited edition, by securing the autograph of a celebrity or artist on the pseudo security or by separately numbering each pseudo security.

### BRIEF DESCRIPTION OF THE DRAWINGS

FIG. 1: A first example of a pseudo security.

FIG. 2: An example of an actual security.

FIG. 3: Flow diagram of the method of the present invention.

FIG. 4: A second example of a pseudo security.

### DESCRIPTION OF THE PREFERRED EMBODIMENT

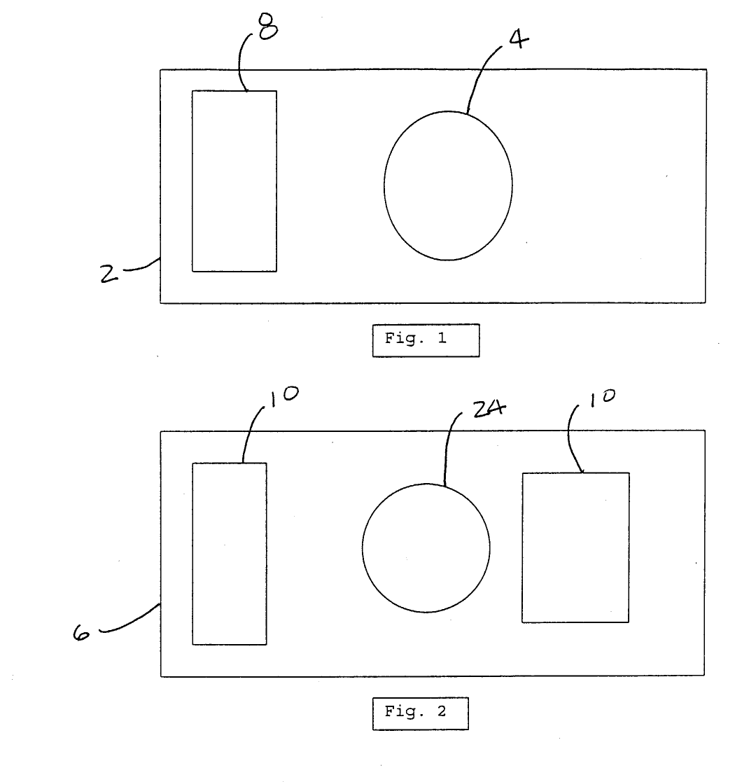

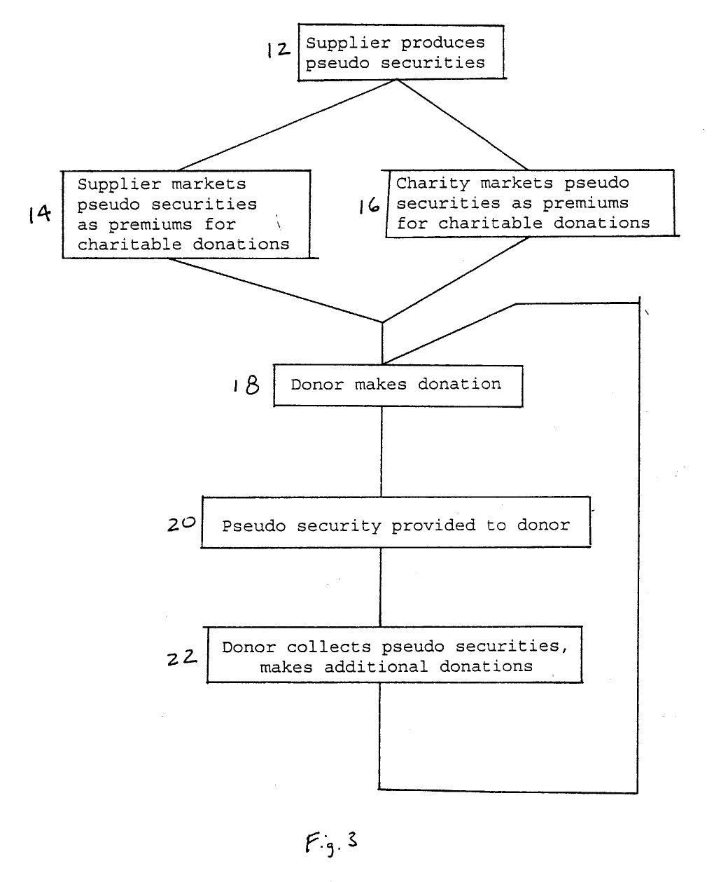

In the preferred embodiment as shown by FIG. 1, a supplier produces a pseudo security 2 bearing the likeness of a celebrity 4. The pseudo security 2 resembles an actual security 6 (FIG. 2) and techniques used to produce actual securities 6 are used to ensure authenticity and prevent unauthorized duplication of the pseudo security 2 and thus to enhance the value of the pseudo security 2 as a collectible. Design elements 8 of the pseudo security 2 are similar to equivalent elements 10 of an actual security 6, also to ensure authenticity, prevent unauthorized duplication and to enhance the value of the pseudo security 2 as a collectible. Although design elements 8 of the pseudo security 2 are similar to corresponding design elements 10 of an actual security 6, the design elements 8 are selected and designed to prevent confusion between a pseudo security 2 and an actual security 6.

The method of the present invention is illustrated by FIG. 3. The supplier of the pseudo security 12 produces the pseudo security 2. The pseudo security 2 is marketed to potential donors either by the supplier 14 or by the charity 16 as a premium to induce donors to make a donation 18 to the charity. The donors are attracted to the pseudo security 2 and make a donation 18 to receive 20 one or more pseudo securities 2. The donors thus collect 22 the pseudo securities 2 and make multiple donations to one or more charities offering the pseudo securities 2 as premiums 18,20,22.

The depiction of a celebrity 4 on a pseudo security 2 mimics images 24 of the type found on actual securities 6 and may be of any person, place or thing in which donors have an interest and desire to collect 22. For example and without limitation, the depiction of a celebrity 4 may depict a stage, screen or music figure, an athlete or other sports figure, a governmental leader or other public figure, a religious leader or other spiritual figure, a literary or scientific figure, a business figure, a financial figure or an academic figure. Alternatively, the depiction of a celebrity 4 may be a depiction of a place or a thing rather than a person. For example and without limitation, the depiction of a celebrity 4 may be of a particular make and model of automobile or of the products of a particular company, or of a local landmark in a community, or of a natural feature of the landscape, or the like. The depiction of a celebrity 4 may be of a symbol, such as a commercial logo or the like. The depiction of a celebrity 4 may be adjusted to meet the needs of a particular charity, as by depicting sites sought to be preserved by an environmental charity.

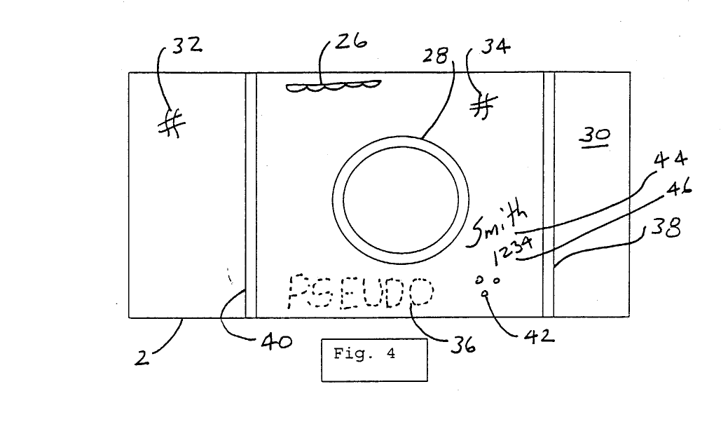

In the preparation and printing of a pseudo security 2, a supplier 12 may use any of the techniques which are known to the art of producing actual securities 6 and which are used to prevent unauthorized duplication and to ensure authenticity of those actual securities 6. For example and without limitation, the design elements may incorporate intaglio printing 26, engraving 28 or other methods for producing microprinting, fine lines, complex designs, panagraphs, microlines and latent images (FIG. 4), all to make unauthorized duplication more difficult. The substrate 30 on which the pseudo security 2 is printed may be comprised of paper and may include colored fibers 32 or fluorescent fibers 34 or may incorporate watermarks 36. The substrate may incorporate holograms 38, continuous threads 40 or microdots 42. The substrate 30 may be chemically sensitive, as by exhibiting a stain in response to solvents or bleaching agents. The printing inks 26, 28 may be thermochromic or ultraviolet-sensitive. Each of these methods for guaranteeing authenticity of a pseudo security is well known in the security paper art. The foregoing recitation is not intended to limit in any way the manner in which unauthorized duplication of the pseudo security 2 may be discouraged and authenticity assured.

In the preferred embodiment, the supplier 12 of the pseudo security 2 will sell the pseudo security 2 to the charity and the charity will conduct all fund raising efforts and marketing of the pseudo securities to potential donors 16. The charity performs the marketing 16 and product delivery 20 tasks either itself or through the services of a contractor. In the preferred embodiment, the charity either pays the supplier of the pseudo securities outright, or pays the supplier for each pseudo security actually used as a premium.

Alternatively, the supplier 12 of the pseudo security 2 may conduct marketing 14 of the pseudo securities 2. Marketing efforts by the supplier of the pseudo securities 14 are either instead of or in conjunction with marketing efforts by the charity or its contractors 16. If the supplier of the pseudo securities conducts marketing 14, the supplier markets in the name of the charity. For each donation received 18 by the supplier of the pseudo securities 2, the supplier retains a portion of each donation 18 to cover expenses and to provide a profit to the supplier. The supplier forwards the balance of the donation to the charity. Marketing by the supplier 14 or by the charity 16 to potential donors may be by any means available, including print or broadcast media, direct mail, personal solicitation, or through an Internet web site of the supplier or of the charity.

In the preferred embodiment, placing the autograph 44 of a celebrity or the designer of the pseudo security on the pseudo security itself further enhances the value of the pseudo security as a collectible. A unique number 46 distinguishing each of said pseudo securities further enhances value, as does limiting the number of the pseudo securities issued.

I claim:

1. A method of charitable fund raising comprising:
a. producing a pseudo security, said pseudo security having no monetary value and said pseudo security not being exchangeable for a product or a service;
b. providing said pseudo security to a charitable donor as a premium in return for a donation to a charity.

2. The method of claim 1, said pseudo security including a depiction of a celebrity.

3. The method of claim 2, said celebrity being one of a series of celebrities, said pseudo security being one of a series of pseudo securities, each of said pseudo securities in said series of pseudo securities depicting one of said celebrities in said series of celebrities.

4. The method of claim 2, said celebrity being a person, place or thing of interest to said donor.

5. The method of claim 4, said pseudo security incorporating a design element to ensure authenticity of said pseudo security and to discourage an unauthorized duplication of said pseudo security.

6. The method of claim 5, said design element comprising one of an engraving of fine lines, an engraving of a complex design, a microprinted image, a microline image, a panagraph, a latent image and an intaglio image.

7. The method of claim 5, said design element comprising one of a watermark, a colored fiber, a fluorescent fiber, a hologram, a continuous thread, a chemically sensitive substrate, a thermochromic ink and a ultraviolet-sensitive ink.

8. The method of claim 4 further comprising means for enhancing the value of said pseudo security, said means comprising one of an autograph, a unique number distinguishing each of said pseudo securities, and a limitation in the number of said pseudo securities issued.

9. The method of claim 1, further comprising the intermediate sequential steps of:
a. marketing said pseudo security to said potential donor; and
b. receiving said donation from said donor.

10. The method of claim 9, said marketing of said pseudo security being conducted by one of said charity and a supplier of said pseudo security.

11. The method of claim 10, said marketing comprising one of solicitation of donations through a print media, through a broadcast media, by direct mail, by direct telephone, through an Internet web site controlled by said supplier and through an Internet web site controlled by said charity.

12. A method of charitable fund raising comprising:
a. offering by a charity of a pseudo security to a donor;
b. providing said pseudo security to said donor in exchange for a donation to said charity from said donor, said pseudo security having no monetary value and said pseudo security not being exchangeable for a product or a service.

13. The method of claim 12, said pseudo security including a depiction of a celebrity.

14. The method of claim 13, said celebrity being one of a series of celebrities, said pseudo security being one of a series of pseudo securities, each of said pseudo securities in said series of pseudo securities depicting one of said celebrities in said series of celebrities.

15. The method of claim 13, said celebrity being a person, place or thing of interest to said donor.

16. The method of claim 12, said pseudo security incorporating a design element to discourage an unauthorized duplication of said pseudo security.

17. The method of claim 16, said design element comprising one of an engraving of fine lines, an engraving of a complex design, a microprinted image, a microline image, a panagraph, a latent image and an intaglio image.

18. The method of claim 16, said design element comprising one of a watermark, a colored fiber, a fluorescent fiber, a hologram, a continuous thread, a chemically sensitive substrate, a thermochromic ink and a ultraviolet-sensitive ink.

19. The method of claim 13 further comprising means for enhancing the value of said pseudo security, said means comprising one of an autograph, a unique number distinguishing each of said pseudo securities, and a limitation in the number of said pseudo securities issued.
